(19) United States
(12) Patent Application Publication
(10) Pub. No.: US 2015/0375934 A1
(43) Pub. Date: Dec. 31, 2015

(54) TRASH CAN ASSEMBLY

(71) Applicant: Austin J. Reiser, Arlington, TX (US)

(72) Inventor: Austin J. Reiser, Arlington, TX (US)

(21) Appl. No.: 14/688,382

(22) Filed: Apr. 16, 2015

(51) Int. Cl. B65F 1/06

(52) U.S. Cl. CPC B65F 1/06

(57) ABSTRACT

The present application includes a trash can assembly having a container configured to hold a trash bag. The container includes one or more side walls and a base portion. The side walls extend around the base portion. A door assembly is included within the one or more side walls and selectively operates between an open position and a closed position. A removable tray is located within the base portion and may be removed while the trash bag is within the container. The trash bag is supported by an internal barrier coupled to the one or more side walls. The internal barrier prevents the trash bag from entering the removable tray.

### BACKGROUND

1. Field of the Invention

The present application relates generally to trash cans and, more particularly, to an assembly to ease the removal of trash and cleaning.

2. Description of Related Art

Trash cans are used to store trash prior to disposal. Bags are inserted into a container and then filled with the trash. Trash cans can come with various different types of lids or covers to permit the selective sealing of the lid to contain smell. Also trash cans may include contraptions to permit the opening of the lid with our feet by pushing a pedal. These advancements have made some improvements for society.

However, a disadvantage of typical trash cans revolves around their inability to release the full trash bag and in their difficulty in cleaning. Usually as a trash bag fills up, the walls of the bag press against the sides of the trash can. This can cause a vacuum effect where attempts to remove the bag are hindered, the bag not being able to slide against the walls of the trash can due to the vacuum. If the vacuum effect is great enough, rips or tears in the trash bags can occur.

Additionally, the top portion of trash bags usually fold over the top of the trash can. It is common that the top of the bags fall down inside the trash can as items are tossed into the can. The liquids and particulates collect on the bottom and cause odors that persist even after the bag has been replaced. Cleaning the trash can is made difficult by having to reach down inside to collect particulates and scrub the bottom of the trash can. Some trash cans will use inserts the same size as the trash can internally to allow a user to take the insert outside to clean as opposed to the entire trash can assembly. However this still requires the user to reach down inside to adequately clean.

Another disadvantage to traditional trash cans is that removal of the trash bag requires lifting the trash bag out of the container. For some individuals, this requires them to lift a portion of the trash bag over their head. For elderly individuals or those with injuries, lifting may become difficult. The need to lift the trash bag for removal is also complicated by the vacuum effect noted above.

It is desirable to provide a trash can assembly to improve cleaning access to the bottom portion of the trash can and allow for a more simple removal of the trash bag from the trash can. Although great strides have been made, considerable shortcomings remain.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a perspective view of a trash can assembly according to the preferred embodiment of the present application;

FIG. 2 is a side view of the trash can assembly of FIG. 1;

FIG. 3 is a top section view of the trash can assembly of FIG. 1; and

FIG. 4 is a partial side section view of a lower portion of the trash can assembly of FIG. 1.

While the assembly and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The assembly and method in accordance with the present application overcomes one or more of the above-discussed problems commonly associated with conventional trash cans. Specifically, the assembly of the present application is configured to include a door assembly to remove suction pressure within the trash can as the trash bag is removed. The door assembly is formed along the side of the trash can and selectively opens as necessary, thereby allowing the trash bag to tip out from the trash can. The door assembly is configured to seal shut, in a closed position, and is held in the closed position by one or more retainers. Additionally, the assembly of the present application is also configured to permit the selective removal of a base portion of the trash can to ease cleaning. The trash bag is separated from the removable base portion by a barrier so as to permit removal of the base portion while the trash bag is held within the trash can. These and other unique features of the assembly are discussed below and illustrated in the accompanying drawings.

The assembly will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The trash can assembly of the present application is illustrated in the associated drawings. The assembly includes a trash can having a base and walls, a door, an internal floor barrier, and a removable tray.

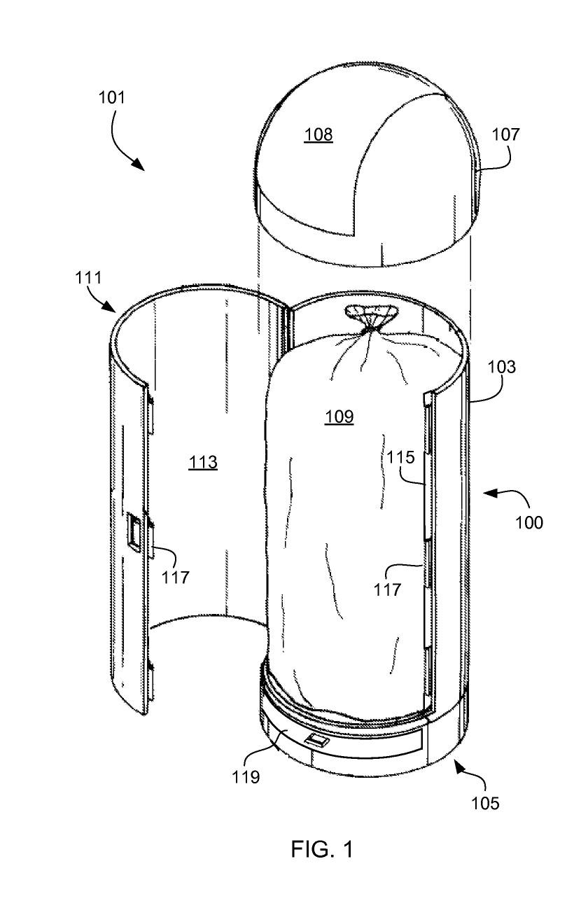

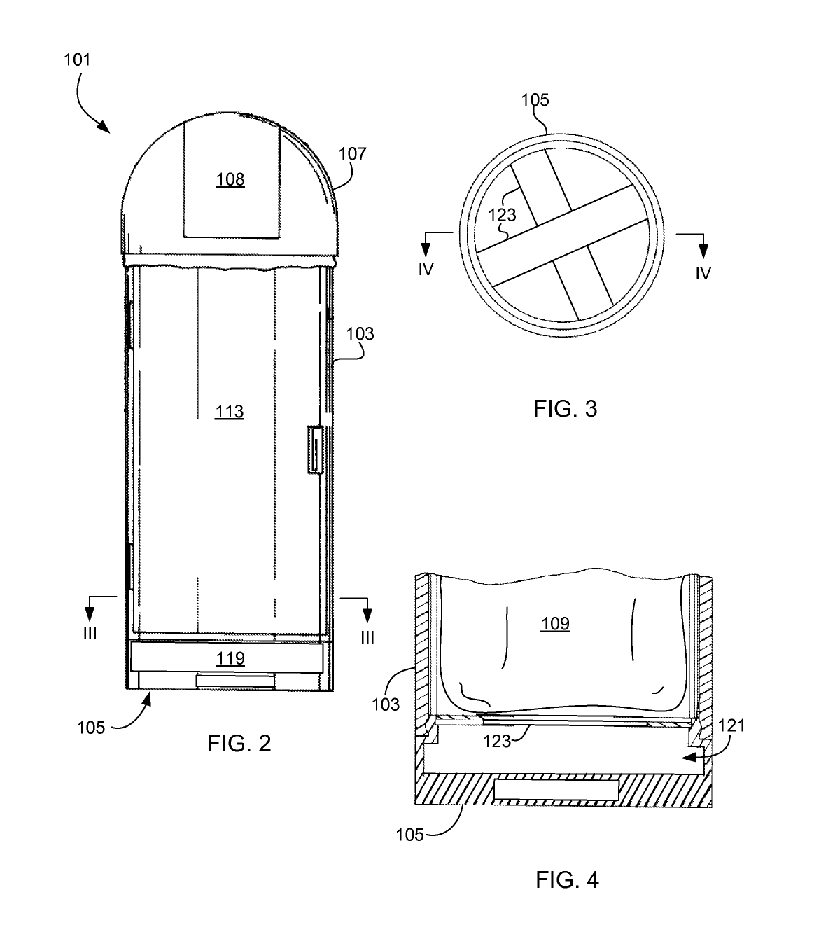

Referring now to the drawings wherein like reference characters identify corresponding or similar elements in form and function throughout the several views. FIGS. 1 and 2 in the drawings illustrate a trash can assembly 101. Assembly 101 includes a container 100 having one or more side walls 103 and a base portion 105. The walls 103 are coupled to the base portion 105 so as to form a central volume. The central volume is bounded by walls 103 on the sides and base portion 105 on the bottom. The upper area of the central volume is optionally bounded by a lid 107. A trash bag 109 is configured to lie within the central volume. It is understood that lid 107 may be that shown in FIGS. 1 and 2 with a manually operated swivel door 108, however other embodiments may permit additional functions of lid 107. For example, lid 107 may be configured to selectively open prior to trash being placed. This may be done manually by a foot or motion sensor.

Walls 103 further includes a door assembly 111 having a door 113 hingedly coupled to neighboring walls 103. Walls 103 may include a single wall formed to surround a volume or consist of multiple individual members combined together to form an enclosed volume. The hinged door 113 of assembly 111 is configured to selectively operate between an open position and a closed position. When opened, door 113 can open to any angle relative to other walls 103. For example, door 113 can open 270 degrees relative to the opening. When closed, door 113 rotates about the hinges and engages one or more of the walls 103 opposite the hinges.

Door assembly 111 may further includes a seal 115 that is configured to extend along the opening between walls 103 and door 113 and also optionally between door 113 and base portion 105. Seal 115 is configured to prevent the passage of particulates and liquids from within the enclosed volume of container 103 from escaping. The liquids and particulates of concern are those that have leaked from trash bag 109 or have somehow managed to pass down along the internal surface of walls 103/door 113 and progressed down toward base portion 105.

Door assembly 111 may also further include a retainer 117. Retainer 117 is configured to hold door 113 in the closed position and provide sufficient resistance to accidental or inadvertent openings generated from trash being placed within the trash bag 109. An example of a suitable retainer 117 is a magnet wherein one portion is attached to door 113 and the other portion being attached to walls 103. When closed, the magnets are attracted to each other generating sufficient force to overcome internal forces of trash existing within trash bag 109 and being placed within trash bag 109. Another example of retainer 117 is a device that is secured by interference fit. In this example door 113 may have a knob and walls 103 may have a suitable receptacle, such that the knob is pressed into the receptacle and is held by interference fit.

In use, trash bag 109 is placed within walls 103. Trash is placed within trash bag 103 until it reaches a desired level (i.e. full). At which time trash bag 109 is removed. Instead of lifting trash bag 109 up through the enclosed volume of walls 103, risking tearing of the bag due to any suction pressure that has developed from bag 109 being pressed against walls 103, door 113 may be opened so as to expose the side of trash bag 109. With the door 113 opened, a user merely has to tip trash bag 109 out from the opening created by the open door 113. In this process, the act of removing the trash bag 109 avoids suction/vacuum pressures and also does not require the user to lift trash bag 109 to a height double the height of the bag 109. The act of tipping the trash bag 109 out of container 100 allows the trash bag 109 to remain approximately at waist level during removal.

Referring now also to FIG. 4 in the drawings, a partial side section view of a lower portion of assembly 101 is illustrated. Base portion 105 is coupled to walls 103 and forms the bottom of assembly 101. Liquids and particulates that pass around or through trash bag 109 are contained within base portion 105. Base portion 105 includes an internal removable tray 119 configured to rest below trash bag 109 and to falling liquids and particulates within the enclosed volume. Tray 119 slides within a designated track or slot 121 and may be repeatedly removed and replaced within base portion 105.

Referring now also to FIG. 3 in the drawings, a top section view of assembly 101 is illustrated. FIG. 3 particularly illustrates an internal floor barrier that is configured to support the trash bag 109 within the container 100. Barrier 123 is located between the enclosed volume within walls 103 and tray 119. Barrier 123 is configured to prevent trash bag 109 from passing into the volume within tray 119. Use of barrier 123 allows for removable tray 119 to enter and leave along slots 121 of base portion 105 while trash bag 109 is within container 100. This provides a great advantage in that a user may clean and remove liquids and particulates from the bottom of container 100 at any time without the need to remove trash bag 109. Cleaning may occur at periodic intervals irrespective of the timing of trash bag's 109 removal. Also, the bottom of trash bag 109 is kept free of contamination of the liquids and particulates such that upon removal, the external base of the trash bag is free of contamination.

It is understood that barrier 123 may take many forms or shapes and still remain within the scope of the present application. Barrier 123 may include a mesh of material spanning between walls 103 or may include a plurality of protruding members extending from walls 103 for example. The shape and design of barrier 123 is not limited to that illustrated. Additionally, handles may be located on door 113 and tray 119 as necessary to provide a point of engagement by a user so as to operate each. Also in instances wherein assembly 101 includes a hands free manually operated lid assembly, a passage for linkages for a foot pedal is located below a portion of slot 121. Lastly, it is to be understood that the base portion 105 and tray 119 may be used with a container that has walls but no door assembly or door.

The current application has many advantages over the prior art including at least the following: (1) ability to remove trash bags from a container without experiencing suction forces; (2) a door to permit the removal of the trash bag by tipping the bag out of the container; (3) a removable tray used to collect liquids and particulates; (4) the removable tray permitting the ability to clean the bottom of the container while the bag remains within the enclosed volume; and (5) an internal barrier to separate the trash bag from the removable tray.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A trash can assembly, comprising:
a container configured to hold a trash bag, the container includes one or more side walls and a base portion, the side walls extend around the base portion;
a door assembly included within the one or more side walls, the door assembly configured to selectively operate between an open position and a closed position, the door assembly including a door;
a removable tray located within the base portion; and
an internal barrier coupled to the one or more side walls, the internal barrier configured to support the trash bag within the container, the internal barrier preventing the trash bag from entering the removable tray;
wherein the removable tray is configured to enter and leave the base portion while the trash bag is within the container.

2. The trash can assembly of claim 1, wherein the door assembly further includes a seal between the one or more walls and the door to prevent the passage of liquids and particulates.

3. The trash can assembly of claim 1, wherein the door assembly includes a retainer configured to hold the door in the closed position.

4. The trash can assembly of claim 3, wherein the retainer is a magnet.

5. The trash can assembly of claim 3, wherein the retainer is a press fit fastener, such that a portion of the door is secured by interference fit to the one or more walls.

6. The trash can assembly of claim 1, further comprising:
a lid configured to selectively rest on the one or more walls of the container.

7. The trash can assembly of claim 6, wherein a portion of the lid selectively opens prior to trash being placed in the trash bag.

8. The trash can assembly of claim 1, wherein the internal barrier is configured to permit the passage of liquid and particulates to enter the removable tray.

9. The trash can assembly of claim 1, wherein the removable tray is configured to permit the periodic removal and cleaning of liquid and particulates from the trash can.

10. The trash can assembly of claim 1, wherein cleaning below the trash bag can occur with the trash bag inside the container.

11. A method of operating a trash can, comprising:
obtaining a container, the container including one or more walls being supported by a base portion;
inserting a trash bag into the container between the one or more walls;
filling the trash bag; and
removing a tray within the base portion, the tray being below the trash bag, the trash bag being supported by an internal barrier to separate the trash bag from the tray;
wherein removal of the tray allows a user to remove excess liquids and particulates from beneath the trash bag.

12. The method of claim 11, further comprising:
removing the trash bag from the container by opening a door within a door assembly and transporting the trash bag through the opening of the door, the door being integrated within the one or more walls.

13. The method of claim 11, wherein the door assembly includes a retainer configured to hold the door in a closed position.

14. The method of claim 13, wherein the retainer is a magnet.

15. The method of claim 13, wherein the retainer is a press fit fastener, such that a portion of the door is secured by interference fit to the one or more walls.

16. The method of claim 11, wherein the internal barrier is configured to permit the passage of liquid and particulates to enter the removable tray.

17. The method of claim 11, wherein cleaning below the trash bag can occur with the trash bag inside the container.
